(19) United States
(12) Patent Application Publication
(10) Pub. No.: US 2025/0330397 A1
(43) Pub. Date: Oct. 23, 2025

(54) METHODS, SYSTEMS, ARTICLES OF MANUFACTURE AND APPARATUS TO MANAGE NETWORK SLICES

(71) Applicants: Shu-ping Yeh, San Jose, CA (US); Abhinanda Dutta, Philadelphia, PA (US); Menglei Zhang, Portland, OR (US); Shiva Radhakrishnan Iyer, Sunnyvale, CA (US)

(72) Inventors: Shu-ping Yeh, San Jose, CA (US); Abhinanda Dutta, Philadelphia, PA (US); Menglei Zhang, Portland, OR (US); Shiva Radhakrishnan Iyer, Sunnyvale, CA (US)

(21) Appl. No.: 19/253,160

(22) Filed: Jun. 27, 2025

Related U.S. Application Data
(60) Provisional application No. 63/786,635, filed on Apr. 10, 2025.

(51) Int. Cl. H04L 41/5009; H04L 43/0888

(52) U.S. Cl. CPC H04L 41/5009; H04L 43/0888

(57) ABSTRACT

Systems, apparatus, articles of manufacture, and methods are disclosed to manage network slices. A disclosed example includes accessing radio access network (RAN) data from a hierarchical network during a first time, determining a load for a plurality of slices associated with a lower level of the hierarchical network, detecting a service level agreement (SLA) violation rate associated with aggregated first predicted throughput (TP) values associated with an upper level of the hierarchical network, detecting an overprovisioning violation rate associated with the first TP values associated with the upper level of the hierarchical network, and training a machine learning (ML) prediction model with a loss function based on the load, the SLA violation rate, and the overprovisioning violation rate.

### RELATED APPLICATION

This patent claims the benefit of U.S. Provisional Patent Application No. 63/786,635, which was filed on Apr. 10, 2025. U.S. Provisional Patent Application No. 63/786,635 is hereby incorporated herein by reference in its entirety. Priority to U.S. Provisional Patent Application No. 63/786,635 is hereby claimed.

### BACKGROUND

Network performance is affected by any number of conditions, such as network node health and dynamic network demand. Network users expect a particular quality of service (QOS) that may be guided by service level objectives and/or service level agreements (SLAs).

### BRIEF DESCRIPTION OF THE DRAWINGS

FIG. 1 is a block diagram of an example hierarchical resource provisioning framework including global slice management circuitry that operates to manage network slices in accordance with teachings disclosed herein.

FIG. 2 is a block diagram of an example implementation of the global slice management circuitry of FIG. 1 to manage network slices in accordance with teachings disclosed herein.

FIG. 3 is a block diagram of an example framework implemented by the example global slice management circuitry of FIGS. 1 and 2 to manage network slices in accordance with teachings disclosed herein.

FIGS. 4-6 are a flowcharts representative of example machine readable instructions and/or example operations that may be executed, instantiated, and/or performed by example programmable circuitry to implement the global slice management circuitry of FIG. 2 to manage network slices in accordance with teachings disclosed herein.

FIG. 7 is a block diagram of an example processing platform including programmable circuitry structured to execute, instantiate, and/or perform the example machine readable instructions and/or perform the example operations of FIGS. 4-6 to implement the global slice management circuitry of FIG. 2.

FIG. 8 is a block diagram of an example implementation of the programmable circuitry of FIG. 7.

FIG. 9 is a block diagram of another example implementation of the programmable circuitry of FIG. 7.

FIG. 10 is a block diagram of an example software/firmware/instructions distribution platform (e.g., one or more servers) to distribute software, instructions, and/or firmware (e.g., corresponding to the example machine readable instructions of FIGS. 4-6) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

To fulfill diverse communication requirements for different industry segments, mobile operators utilize network slicing, which allows multiple logical networks to operate utilizing a common physical infrastructure. Network slices are implemented with virtualization, but may share the same physical components. These common physical components have limits regarding throughput capabilities. As such, the throughput demands of a first slice may affect throughput capabilities of a second slice. Typically, network slices may include localized network slices that are associated with a portion of a network (e.g., a localized network that is part of a larger global network) subjected to service level agreements (SLAs), which provide assurances of the level of performance the network slice will experience.

Service level objectives (SLOs) and/or service level agreements (SLAs) include and/or otherwise represent metrics (e.g., throughput metrics) that specify an agreed quality of service (QOS). On the one hand, if a first slice is dynamically allocated a first portion of the physical network infrastructure, a second slice may be restricted to utilize a remaining second portion of that underlying network infrastructure. In that regard, if the throughput for the first slice is overprovisioned (e.g., an overprovisioning condition), then an SLA violation (e.g., an SLA violation condition) may be experienced by the second slice.

Some examples disclosed herein include a hierarchical resource provisioning framework in which a global network slice planner at an upper level of the hierarchical resource provisioning framework collects measurements from any number of local network slice managers, predicts traffic loads (e.g., throughput), and calculates local throughput (TP) target values for the local network slice managers based on a global SLA performance target (e.g., a global SLA target TP value). Some examples disclosed herein utilize a machine learning (ML) prediction model to generate throughput predictions in connection with an operator-defined TP-target policy to set the local TP target values in a manner that reduces occurrences of SLA violations or instances of overprovisioning.

Some examples disclosed herein generate a custom loss function to update gradient descent operations of the machine learning prediction model, in which the loss function updates parameters of the model during training iterations. Examples disclosed herein manage network slices in a large geographical area and enable relatively smaller area localized slice managers (e.g., slice manager circuitry) to react to network variations (e.g., channel variations). The custom loss function enables some examples disclosed herein to consider policies defined and/or otherwise selected by the localized slice managers. The policies enable the ML prediction model (e.g., neural network) to predict traffic in a manner that reduces an SLA violation rate.

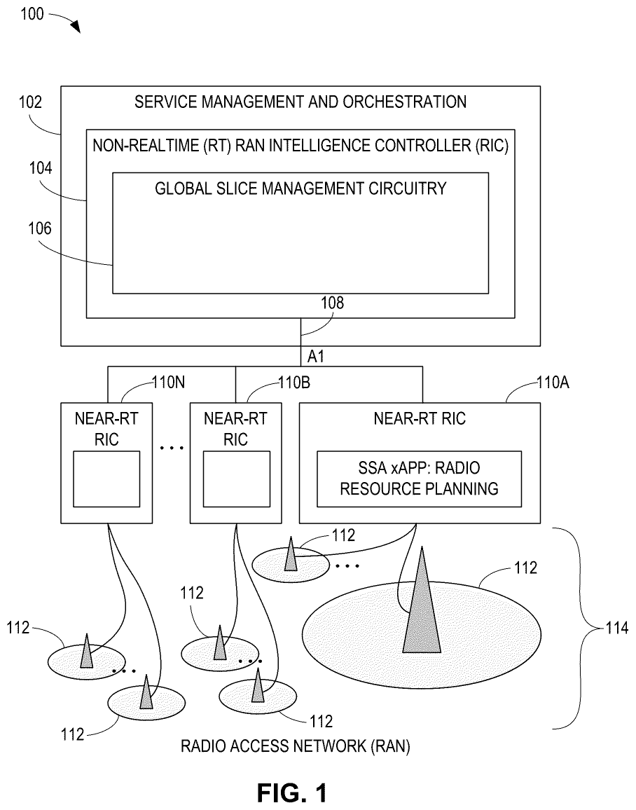

FIG. 1 is a block diagram of an example hierarchical resource provisioning framework 100 (hereinafter “the framework”). In the illustrated example of FIG. 1, the framework 100 includes service management and orchestration services 102, a non-real time (RT) radio access network (RAN) intelligence controller (RIC) 104, global slice management circuitry 106, and a signaling network (A1) 108 communicatively connected to any number of local slice management circuitry 110. The example framework 100 of FIG. 1 includes first local slice management circuitry 110A, second local slice management circuitry 110B, and any number of other slice management circuits represented here as Nth local slice management circuitry 110N. Respective local slice management circuitry 110 controls any number of base stations 112 of a RAN 114. In some examples, slice management circuitry 110 includes a near-real-time RIC hosting a slice SLA assurance (SSA) xApp to compute and/or otherwise determine radio resource allocation for different slices based on guidance provided by the global slice management circuitry 106. The example service management and orchestration services 102 portion of the hierarchical framework 100 represents an upper level of the hierarchy, and the slice management circuitry 110 and base stations 112 represent a lower level of the hierarchical structure 100.

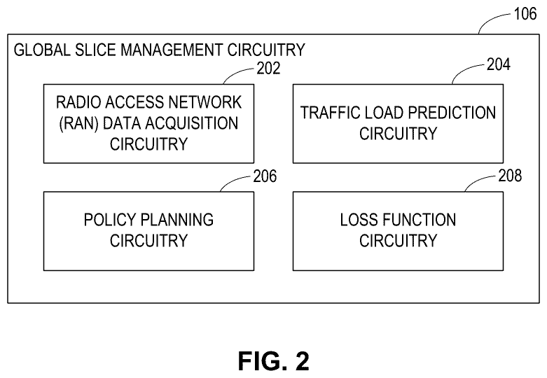

FIG. 2 is a block diagram of an example implementation of the global slice management circuitry of FIG. 1. The global slice management circuitry 106 of FIG. 2 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the global slice management circuitry of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

In the illustrated example of FIG. 2, the global slice management circuitry 106 includes example radio access network (RAN) data acquisition circuitry 202, example traffic load prediction circuitry 204, example policy planning circuitry 206, and example loss function circuitry 208.

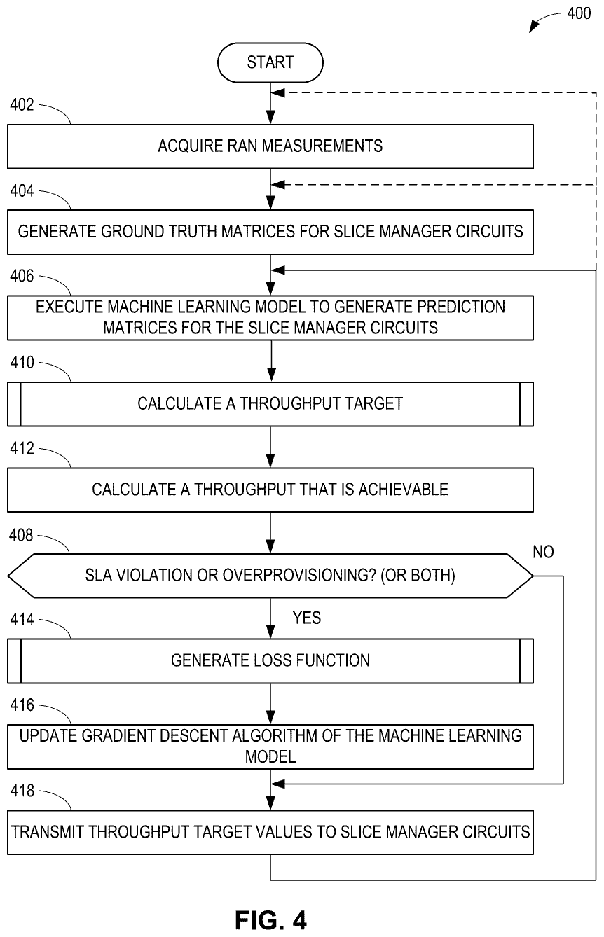

In some examples, the global slice management circuitry 106 is instantiated by programmable circuitry executing slice management instructions and/or configured to perform operations such as those represented by the flowchart(s) of FIG. 4-6.

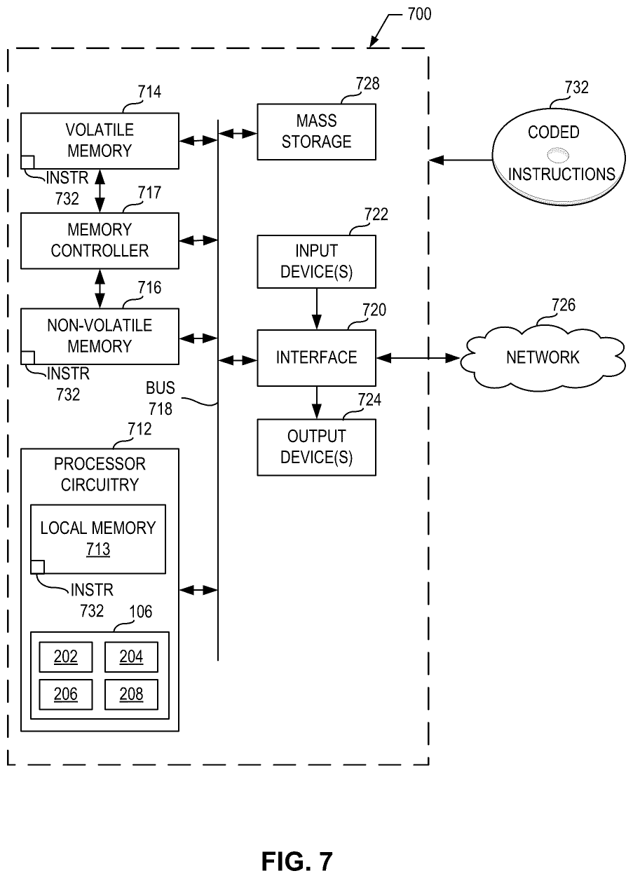

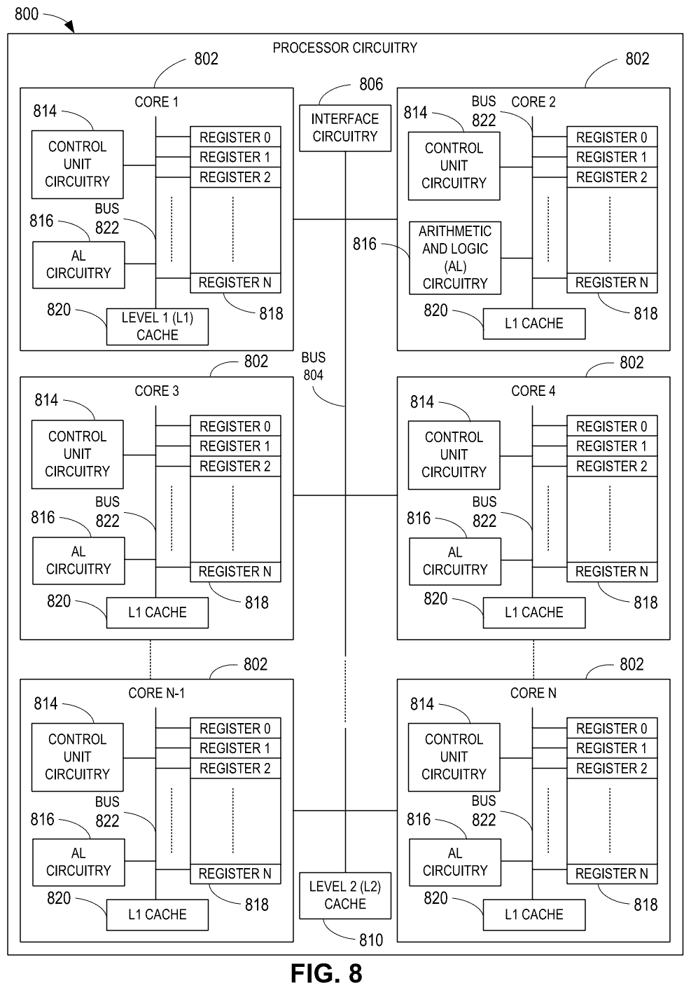

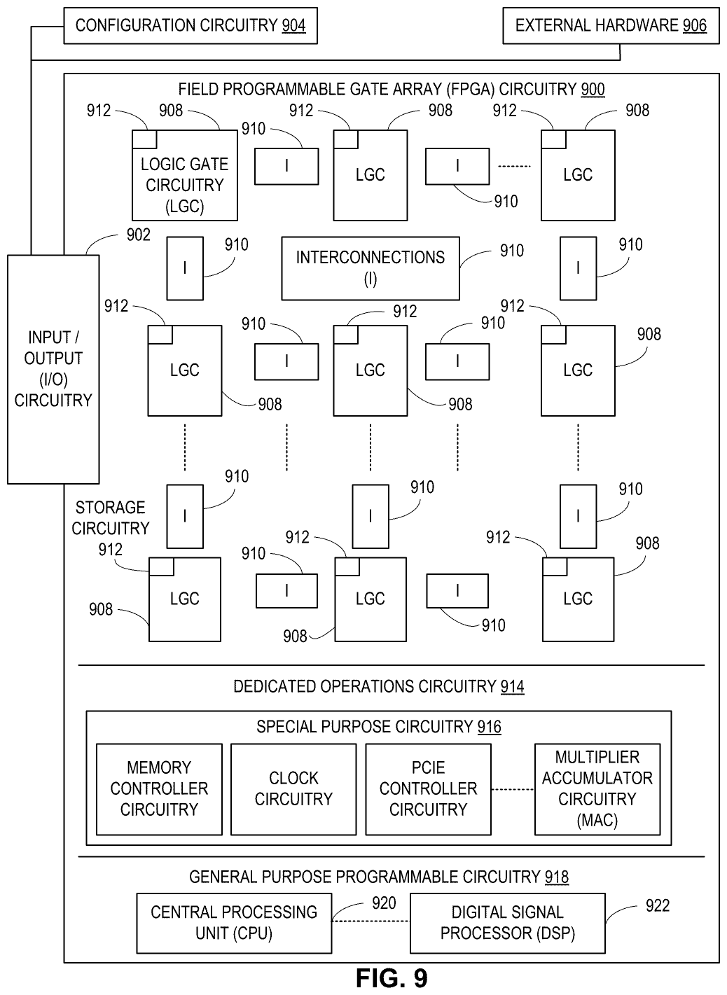

In some examples, the global slice management circuitry includes means for managing slices. For example, the means for managing slices may be implemented by global slice management circuitry 106. In some examples, the global slice management circuitry 106 may be instantiated by programmable circuitry such as the example programmable circuitry 712 of FIG. 7. For instance, the global slice management circuitry 106 may be instantiated by the example microprocessor 800 of FIG. 8 executing machine executable instructions such as those implemented by at least blocks 402-418 of FIG. 4. In some examples, the global slice management circuitry 106 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the global slice management circuitry 106 may be instantiated by any other combination of hardware, software, and/or firmware. For example, the global slice management circuitry 106 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the RAN data acquisition circuitry 202 is instantiated by programmable circuitry executing data acquisition instructions and/or configured to perform operations such as those represented by the flowchart(s) of FIG. 4.

In some examples, the global slice management circuitry includes means for data acquisition. For example, the means for data acquisition may be implemented by RAN data acquisition circuitry 202. In some examples, the RAN data acquisition circuitry 202 may be instantiated by programmable circuitry such as the example programmable circuitry 712 of FIG. 7. For instance, the RAN data acquisition circuitry 202 may be instantiated by the example microprocessor 800 of FIG. 8 executing machine executable instructions such as those implemented by at least blocks 402, 404 and 418 of FIG. 4. In some examples, the RAN data acquisition circuitry 202 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the RAN data acquisition circuitry 202 may be instantiated by any other combination of hardware, software, and/or firmware. For example, the RAN data acquisition circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the traffic load prediction circuitry 204 is instantiated by programmable circuitry executing load prediction instructions and/or configured to perform operations such as those represented by the flowchart(s) of FIG. 4.

In some examples, the global slice management circuitry includes means for prediction. For example, the means for prediction may be implemented by traffic load prediction circuitry 204. In some examples, the traffic load prediction circuitry 204 may be instantiated by programmable circuitry such as the example programmable circuitry 712 of FIG. 7. For instance, the traffic load prediction circuitry 204 may be instantiated by the example microprocessor 800 of FIG. 8 executing machine executable instructions such as those implemented by at least blocks 406 of FIG. 4. In some examples, the traffic load prediction circuitry 204 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the traffic load prediction circuitry 204 may be instantiated by any other combination of hardware, software, and/or firmware. For example, the traffic load prediction circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

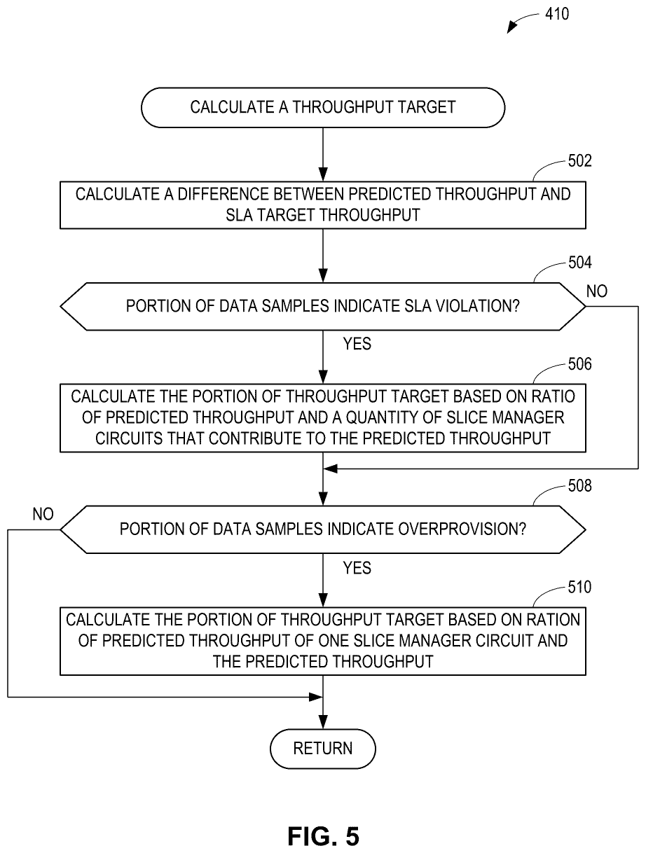

In some examples, the policy planning circuitry 206 is instantiated by programmable circuitry executing policy planning instructions and/or configured to perform operations such as those represented by the flowchart(s) of FIGS. 4 and 5.

In some examples, the global slice management circuitry includes means for planning. For example, the means for planning may be implemented by policy planning circuitry 206. In some examples, the policy planning circuitry 206 may be instantiated by programmable circuitry such as the example programmable circuitry 712 of FIG. 7. For instance, the policy planning circuitry 206 may be instantiated by the example microprocessor 800 of FIG. 8 executing machine executable instructions such as those implemented by at least blocks 408-412 of FIG. 4 and blocks 502-510 of FIG. 5. In some examples, the policy planning circuitry 206 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the policy planning circuitry 206 may be instantiated by any other combination of hardware, software, and/or firmware. For example, the policy planning circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

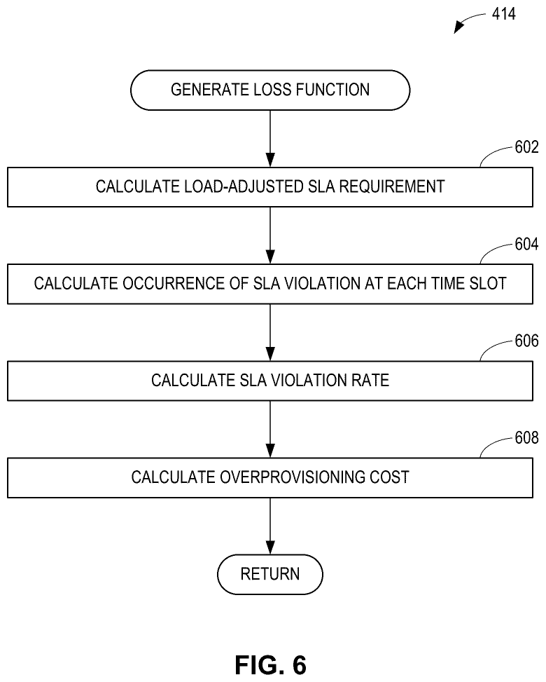

In some examples, the loss function circuitry 208 is instantiated by programmable circuitry executing loss function instructions and/or configured to perform operations such as those represented by the flowchart(s) of FIGS. 4 and 6.

In some examples, the global slice management circuitry includes means for determining a loss function (sometimes referred to as means for loss determination). For example, the means for determining a loss function may be implemented by loss function circuitry 208. In some examples, the loss function circuitry 208 may be instantiated by programmable circuitry such as the example programmable circuitry 712 of FIG. 7. For instance, the loss function circuitry 208 may be instantiated by the example microprocessor 800 of FIG. 8 executing machine executable instructions such as those implemented by at least blocks 414 and 416 of FIG. 4, and blocks 602-608 of FIG. 6. In some examples, the loss function circuitry 208 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the loss function circuitry 208 may be instantiated by any other combination of hardware, software, and/or firmware. For example, the loss function circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In operation, the global slice management circuitry 106 accesses, acquires and/or otherwise obtains radio access network (RAN) data from the RAN. RAN data may be stored in one or more storage and/or memory locations of the hierarchical resource planning framework 100. The RAN data may include throughput data from a lower level of the framework 100, such as throughput data associated with any number of slices having any number of base stations. The global slice management circuitry 106 operates at an upper level of the hierarchical resource planning framework 100 to determine throughput (TP) target values for one or more slice managers (e.g., local slice management circuitry 110) at a lower level of the hierarchical resource planning framework 100. In some examples, the lower level of the hierarchical resource planning framework 100 receives TP target values to be applied to radio planning of one or more base stations. The example global slice management circuitry 106 considers network loads (e.g., load conditions), network capabilities (e.g., achievable and/or otherwise capable throughput), and global SLA targets associated with multi-dimensional policies (e.g., policies that consider two or more network fault behaviors, such as SLA violations and overprovisioning) of the one or more slice managers associated with a network area of interest. Additionally, because individual network slices may have an effect on other slices of the network, examples disclosed herein avoid isolated slice analysis. Instead, some examples disclosed herein determine TP values in a manner that considers all other network slice behaviors. TP target values determined by the example slice management circuitry 106 are provided to any number of lower level slice managers, which utilize the TP target values to establish localized services (e.g., radio network services). Generally speaking, the TP target values determined and/or generated by the slice management circuitry 106 operate as guardrails or boundary conditions for the local slice managers to follow. Additionally, some examples disclosed herein determine throughput target values based on predicted throughput values generated by a machine learning (ML) model that includes a loss function modified by SLA violation rate information and overprovisioning cost information. The loss function may be used to revise, calibrate, train, and/or otherwise tune the machine learning model during training. As such, some examples disclosed herein determine the throughput target values in a manner that reduces SLA violation(s) and/or SLA overprovisioning (e.g., an overprovisioning condition).

In particular, the example RAN data acquisition circuitry 202 acquires RAN measurements associated with a network. In some examples, the network includes a geographic and/or logical assortment of network slices. In the aggregate, the network slices exhibit a global throughput. For a given network slice manager n and a respective slice S, measurement data may be stored in a database. The stored data represents throughput data during a particular period of time (t time steps). The RAN data acquisition circuitry 202 generates a ground truth matrix G of size (N×T) containing ground truth throughput data g_{n,t} for any one of the n^{th} local slice management circuits 110 in a manner consistent with example Equation 1.

$$G = [ \begin{matrix}{g}_{1 , 1} & {g}_{1 , 2} & … & {g}_{1 , N} \\ {g}_{2 , 1} & {g}_{2 , 2} & … & {g}_{2 , N} \\ … & & & \\ … & & & \\ … & & & \\ {g}_{T , 1} & {g}_{T , 2} & … & {g}_{T , N}\end{matrix} ] . \qquad Equation 1$$

In some examples, Equation 1 represents a data structure of ground truth data for the hierarchical network (e.g., a global data structure). Additionally, the traffic load prediction circuitry 204 generates a prediction matrix P of size (N×T) containing predicted throughput data p_{n,t} generated from the ML model. The prediction matrix P includes the predicted throughput data p_{n,t} corresponding to any one of the n^{th} local slice management circuits 110 in a manner consistent with example Equation 2.

$$P = [ \begin{matrix}{p}_{1 , 1} & {p}_{1 , 2} & … & {p}_{1 , N} \\ {p}_{2 , 1} & {p}_{2 , 2} & … & {p}_{2 , N} \\ … & & & \\ … & & & \\ … & & & \\ {p}_{T , 1} & {p}_{T , 2} & … & {p}_{T , N}\end{matrix} ] . \qquad Equation 2$$

In some examples, Equation 2 represents a data structure of predicted throughput values after an iteration of training (or inference) of an ML model. Initial values of the example prediction matrix P may not contain reliable and/or otherwise useful predicted throughput values until a number of ML model training iterations (epochs) have occurred. In some examples, historical throughput values are used to initialize the prediction matrix P.

The example traffic load prediction circuitry 204 generates and/or otherwise defines vectors P′ and G′ of size T to represent a sum of predicted load values and a sum of ground truth values, respectively. The P′ sum vectors and the G′ sum vectors represent values for an area of interest (e.g., a geographic area of interest having any number of local slice management circuitry 110 (N) and associated slices) across T steps. The example P′ and G′ vectors are determined by the traffic load prediction circuitry 204 in a manner consistent with example Equation 3 and example Equation 4, respectively.

$${P}^{′} = [ {p}_{1}^{′} , {p}_{2}^{′} , … , {p}_{T}^{′} ] where {p}_{i}^{′} = {\sum }_{j ∈ \vert N \vert} {p}_{j , i} {∀}_{i} ∈ \vert T \vert . \qquad Equation 3$$

$${G}^{′} = [ {g}_{1}^{′} , {g}_{2}^{′} , … , {g}_{T}^{′} ] where {g}_{i}^{′} = {\sum }_{j ∈ \vert N \vert} {g}_{i , j} ∀ ∈ \vert T \vert . \qquad Equation 4$$

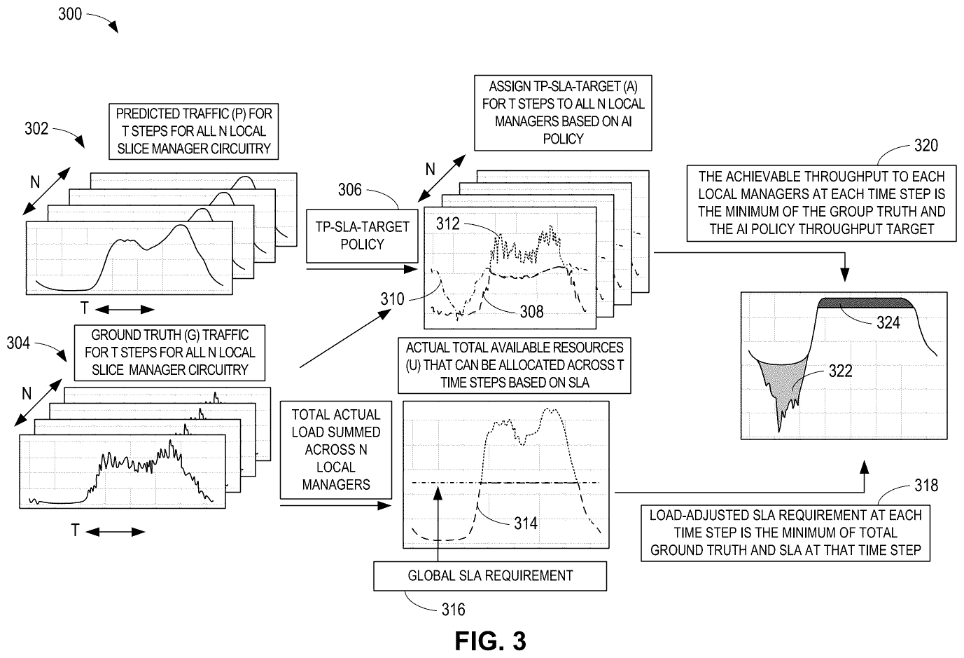

During training iterations the global slice management circuitry 106 calculates an SLA throughput score value to evaluate performance of the predicted throughput data for participating slice management circuitry 110 and the one or more slices associated therewith. FIG. 3 is a block diagram of an example framework 300 to calculate SLA scores. Generally speaking, the example framework 300 enables an ability to determine SLA scores in view of the predicted traffic, a throughput SLA target policy, and ground truth data. The framework 300 determines a difference between predicted throughput and a score indicative of SLA violation and/or overprovisioning. Results of these conditions enable modifications and/or revisions to the loss function used by the ML model during training epochs.

The illustrated example of FIG. 3 includes predicted throughput data 302 from the ML model (e.g., network traffic data, such as throughput). The predicted throughput data 302 corresponds to time steps (T) for all N local slice manager circuitry and ground truth throughput data 304 (e.g., network traffic data, such as throughput) corresponding to time steps (T) for all N local slice manager circuitry. The global slice management circuitry 106 maps the predicted throughput data 302 to a throughput (TP) SLA target policy 306, described in further detail below. The mapping also considers the ground truth throughput data 304 to determine how the TP SLA target policy 306 impacts all slices of the network. The mapping performed by the global slice management circuitry 106 generates a gap profile 308 based on policy profile 310 and a ground truth profile 312. The global slice management circuitry 106 also illustrates the best throughput performance that could be achieved (e.g., capable) 314 in view of the ground truth throughput data 304 and a global SLA requirement 316 (e.g., a constraint based on network capabilities). The global slice management circuitry 106 considers load information 318 and an achievable/capable throughput based on a minimum one of either the ground truth or the target policy 320. The global slice management circuitry 106 combines these considerations to reveal instances of an SLA violation 322, which represents circumstances where the calculated TP SLA target policy 306 fails to deliver the promised SLA requirement. Additionally, the global slice management circuitry 106 combines these considerations to reveal instances of overprovisioning 324, which represents circumstances where network slices receive throughput resources in excess of what is needed (e.g., waste).

Returning to the illustrated example of FIG. 2, the policy planning circuitry 206 determines if an SLA violation and/or an overprovisioning has occurred and calculates a throughput target (aⱼ) for local managers (e.g., local slice management circuitry 110) (j). In some examples, the throughput target (aⱼ) is referred to as a policy. To calculate the throughput target (aⱼ), the policy planning circuitry 206 calculates a difference between a predicted throughput (e.g., from the ML model) and an SLA target throughput in a manner consistent with example Equation 5.

$${a}_{j} = ( {P}^{′} < S L A * ∈ ) ( P \vert {p}_{j , 1} , … , {p}_{j , T} \vert + \frac{S L A * ∈ - {P}^{′}}{N} ) + ( {P}^{′} \geq S L A * ∈ ) ( \frac{P \vert {p}_{j , 1} , … , {p}_{j , T} \vert}{{P}^{′}} * S L A * ∈ ) . \qquad Equation 5$$

In the illustrated example of Equation 5, aⱼ represents an equal throughput margin to all slice management circuitry if there is a global SLA violation at a given time step (e.g., the first half of Equation 5), and represents a margin if there is overprovisioning (e.g., the second half of Equation 5). Stated differently, some examples disclosed herein consider multiple failure conditions or multiple contributions of network inefficiencies (e.g., contributions related to SLA violations and contributions related to overprovisioning). Because a given time period of analysis may include instances of both SLA violations and instances of overprovisioning, the illustrated example of Equation 5 considers the sum contributions of these negative effects. The policy planning circuitry 206 generates a policy matrix A of size (N×T) containing throughput targets for all local slice management circuitry 110 across T time steps in a manner consistent with example Equation 6.

$${A}_{[ t + 1 , t + T ]} = [ \begin{matrix}{a}_{t + 1 , 1} & {a}_{t + 1 , 2} & … & {a}_{t + 1 , N} \\ {a}_{t + 2 , 1} & {a}_{T = 2 , 2} & … & {a}_{t + 2 , N} \\ … & … & … & … \\ {a}_{t + T , 1} & {a}_{t + T , 2} & … & {a}_{t + T , N}\end{matrix} ] . \qquad Equation 6$$

In the illustrated example of Equation 5, if one or more portions of the predicted data samples indicate an SLA violation (e.g., the predicted throughput P′ is less than the SLA target throughput), then the policy planning circuitry 206 calculates that portion(s) of the throughput target based on a ratio of predicted throughput and a quantity of slice management circuitry that contributed to the predicted throughput. On the other hand, if one or more portions of the predicted data samples indicate an overprovisioning occurrence (e.g., the predicted throughput P′ is greater than the SLA target throughput), then the policy planning circuitry 206 calculates that portion(s) of the throughput target based on a ratio of predicted throughput of one slice manager circuit and the predicted throughput.

While the policy (aⱼ) represents a target throughput target (e.g., goal/objective), the policy planning circuitry 206 also considers a throughput that is achievable based on current conditions. The policy planning circuitry 206 estimates, calculates and/or otherwise determines an achievable throughput based on the throughput target and a ground truth load of the network in a manner consistent with example Equation 7.

$$L = {min}_{x i , j \leq {x}^{′} i , j} ( A , G ) {L}^{′} = [ {l}_{1} , {l}_{2} , … , {l}_{T} ] where {l}_{i} = {\sum }_{j ∈ \vert N \vert} {L}_{i , j} ∀ i ∈ \vert T \vert . \qquad Equation 7$$

In the illustrated example of Equation 7, matrix L holds the estimate of achievable throughput for the local slice management circuitry and vector L′ represents the total sum of achievable throughput estimate for all local slice management circuitry at each step.

Based on this information, the loss function circuitry 208 generates a loss function. At each time step, the loss function circuitry 208 calculates a load-adjusted SLA TP requirement (e.g., a global load-adjusted SLA TP value) by taking a minimum of the sum of the ground truth load across all local slice management circuitry at a time step as a function of the global SLA requirement. In some examples, the loss function circuitry 208 generates a vector U of the load-adjusted SLA requirement in a manner consistent with example Equation 8.

$$U = {min}_{x i \leq x j} ( {G}^{′} , SLA ) . \qquad Equation 8$$

In view of the load-adjusted SLA requirement (U) and the sum of achievable throughput (TP) estimates (values) corresponding to the local slice management circuitry (L′) for T time steps, the loss function circuitry 208 calculates an SLA violation rate. In particular, the loss function circuitry 208 determines, at any given time step (tϵT), a violation occurrence in a manner consistent with example Equation 9.

$$f ( {L}^{′} , U ) = \{ \begin{matrix}1 & if {L}^{′} - U < 0 & SLA Violation \\ 0 & if {L}^{′} - U \geq 0 & otherwise\end{matrix} . \qquad Equation 9$$

The example loss function circuitry 208 calculates the SLA violation rate (C) as a mean of the number of times a violation occurs within T time steps in a manner consistent with example Equation 10.

$$C = \frac{{\sum }_{t = 1}^{T} f ( {L}^{′} , U )}{T} . \qquad Equation 10$$

The loss function circuitry 208 also calculates an overprovisioning cost (O) based on such occurrences within T time steps in a manner consistent with example Equation 11.

$$O = \frac{{\sum }_{t = 1}^{T} g ( ( 1 - f ( {L}^{′} , U ) ) * ( {L}^{′} - U ) )}{T} . \qquad Equation 11$$

In the illustrated example of Equation 11, g(·) represents an operator defined cost function that maps overprovisioned data rate(s) (e.g., overprovisioned violation rate(s)) to a corresponding operating cost.

The SLA violation rate is incorporated as a metric to be optimized for a given SLA TP-target planning policy, such as the policy defined in the illustrated example of Equation 5. Training of the ML model occurs as iterations (epochs) to predict traffic (matrix P) for N base stations for T time steps into the future. The loss function circuitry 208 generates the loss function as a weighted sum combination of the SLA violation rate C (see example Equation 10) and the overprovisioning cost O (see example Equation 11).

In some examples, the loss function circuitry 208 invokes a stochastic gradient descent (SGD) optimizer to convert the loss function (e.g., the weighted sum combination of the SLA violation rate C and the overprovisioning cost O) into a differentiable form before providing it to the ML model at each training iteration. As such, the loss function circuitry 208 facilitates weight updates and backpropagation of the ML model during each iteration to update predicted throughput values of the prediction matrix P.

While an example manner of implementing the global slice management circuitry of FIG. 1 is illustrated in FIG. 2, one or more of the elements, processes, and/or devices illustrated in FIG. 2 may be combined, divided, re-arranged, omitted, eliminated, and/or implemented in any other way. Further, the example RAN data acquisition circuitry 202, the example traffic load prediction circuitry 204, the example policy planning circuitry 206, the example loss function circuitry 208 and/or, more generally, the example global slice management circuitry of FIG. 2, may be implemented by hardware alone or by hardware in combination with software and/or firmware. Thus, for example, any of the example RAN data acquisition circuitry 202, the example traffic load prediction circuitry 204, the example policy planning circuitry 206, the example loss function circuitry 208 and/or, more generally, the example global slice management circuitry of FIG. 2, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine readable instructions (e.g., firmware or software). Further still, the example global slice management circuitry of FIG. 2 may include one or more elements, processes, and/or devices in addition to, or instead of, those illustrated in FIG. 2, and/or may include more than one of any or all of the illustrated elements, processes and devices.

Flowchart(s) representative of example machine readable instructions, which may be executed by programmable circuitry to implement and/or instantiate the global slice management circuitry of FIG. 2 and/or representative of example operations which may be performed by programmable circuitry to implement and/or instantiate the global slice management circuitry of FIG. 2, are shown in FIGS. 4-6. The machine readable instructions may be one or more executable programs or portion(s) of one or more executable programs for execution by programmable circuitry such as the programmable circuitry 712 shown in the example processor platform 700 discussed below in connection with FIG. 7 and/or may be one or more function(s) or portion(s) of functions to be performed by the example programmable circuitry (e.g., an FPGA) discussed below in connection with FIGS. 8 and/or 9. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 4-6, many other methods of implementing the example global slice management circuitry may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 4-6 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 4 is a flowchart representative of example machine readable instructions and/or example operations 400 that may be executed, instantiated, and/or performed by programmable circuitry to manage network slices. The example machine-readable instructions and/or the example operations 400 of FIG. 4 begin at block 402, at which the RAN data acquisition circuitry 202 acquires RAN measurements. In some examples, RAN measurements from a network correspond to a particular time duration and are stored in a database for analysis. The RAN data acquisition circuitry 202 generates a ground truth matrix corresponding to any number of slice manager circuitry 110 of the RAN 114 (block 404). The traffic load prediction circuitry 204 executes a machine learning model to generate prediction throughput data (block 406), such as the prediction throughput data in the illustrated prediction matrix P of Equation 2.

The policy planning circuitry 206 calculates a throughput target (block 410) and also calculates a throughput that is achievable (block 412). The example policy planning circuitry 206 determines whether an SLA violation or an overprovisioning violation occurs (block 408). If not, control advances to block 418, described in further detail below. However, in the event of one or both of an SLA violation or an overprovisioning instance (block 408), the loss function circuitry 208 generates a loss function, as described above and in further detail below.

The example loss function circuitry 208 generates a loss function (block 414) and updates a gradient descent algorithm corresponding to the machine learning model (block 416). Based on revised weights and backpropagation caused by the loss function circuitry 208, the RAN data acquisition circuitry 202 transmits throughput target values to one or more slice manager circuits (block 418). In some examples, control returns to block 404 to perform one or more training epochs on a previously stored batch of RAN measurements. In some examples, control returns to block 402 to acquire additional and/or alternate RAN measurements prior to performing one or more training epochs. In some examples, training operations may cease based on a number of epochs or measurements related to diminishing returns between epochs. In such circumstances the ML prediction model may be distributed (e.g., to one or more computing resources) for inference operations.

FIG. 5 illustrates additional detail corresponding to calculating a throughput target corresponding to block 410 of FIG. 4. In the illustrated example of FIG. 5, the policy planning circuitry 206 calculates a difference between the predicted throughput and an SLA target throughput (block 502). As described above, difference calculations and resulting results may indicate an SLA violation occurrence or an instance of resource overprovisioning. In the event the policy planning circuitry 206 determines an SLA violation (block 504), the policy planning circuitry 206 calculates a portion of the throughput target based on a ratio of the predicted throughput and a quantity of slice manager circuits that contribute to and/or are otherwise associated with the predicted throughput (block 506).

In the event the policy planning circuitry 206 determines that an SLA violation has not occurred (block 504), the policy planning circuitry 206 determines if a portion of the data samples indicate an overprovisioning occurrence (block 508). If so, the policy planning circuitry 206 calculates the portion of throughput target based on a ratio of the predicted throughput of one slice manager circuit and the predicted throughput (block 510). In the event the policy planning circuitry 206 determines that an overprovisioning instance is not true (block 508), the example program 410 returns to block 412 of FIG. 4.

FIG. 6 illustrates additional detail corresponding to generating a loss function corresponding to block 414 of FIG. 4. In the illustrated example of FIG. 6, the loss function circuitry 208 calculates a load-adjusted SLA requirement in a manner consistent with example Equation 8 (block 602). The loss function circuitry 208 calculates an occurrence of SLA violations at each time slice in a manner consistent with example Equation 9 (block 604). The loss function circuitry 208 calculates an SLA violation rate in a manner consistent with example Equation 10 (block 606). The loss function circuitry 208 calculates an overprovisioning cost in a manner consistent with example Equation 11 (block 608).

FIG. 7 is a block diagram of an example programmable circuitry platform 700 structured to execute and/or instantiate the example machine-readable instructions and/or the example operations of FIGS. 4-6 to implement the global slice management circuitry of FIG. 2. The programmable circuitry platform 700 can be, for example, a server, a personal computer, a workstation, a self-learning machine (e.g., a neural network), a mobile device (e.g., a cell phone, a smart phone, a tablet such as an iPad™), an Internet appliance, a gaming console, a set top box, a headset (e.g., an augmented reality (AR) headset, a virtual reality (VR) headset, etc.) or other wearable device, or any other type of computing and/or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAs, microprocessors, CPUs, GPUs, VPUs, DSPs, and/or microcontrollers from any desired family or manufacturer. The programmable circuitry 712 may be implemented by one or more semiconductor based (e.g., silicon based) devices. In this example, the programmable circuitry 712 implements the example global slice management circuitry 106, the example RAN data acquisition circuitry 202, the example traffic load prediction circuitry 204, the example policy planning circuitry 206, and the example loss function circuitry 208.

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716.

The programmable circuitry platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, an audio sensor, a microphone, a camera (still or video), a keyboard, a button, a mouse, a touchscreen, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 700 of the illustrated example also includes one or more mass storage discs or devices 728 to store firmware, software, and/or data. Examples of such mass storage discs or devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 732, which may be implemented by the machine readable instructions of FIGS. 4-6, may be stored in the mass storage device 728, in the volatile memory 714, in the non-volatile memory 716, and/or on at least one non-transitory computer readable storage medium such as a CD or DVD which may be removable.

FIG. 8 is a block diagram of an example implementation of the programmable circuitry 712 of FIG. 7. In this example, the programmable circuitry 712 of FIG. 7 is implemented by a microprocessor 800. For example, the microprocessor 800 may be a general-purpose microprocessor (e.g., general-purpose microprocessor circuitry). The microprocessor 800 executes some or all of the machine-readable instructions of the flowcharts of FIGS. 4-6 to effectively instantiate the circuitry of FIG. 2 as logic circuits to perform operations corresponding to those machine readable instructions. In some such examples, the circuitry of FIG. 2 is instantiated by the hardware circuits of the microprocessor 800 in combination with the machine-readable instructions. For example, the microprocessor 800 may be implemented by multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowcharts of FIGS. 4-6.

The cores 802 may communicate by a first example bus 804. In some examples, the first bus 804 may be implemented by a communication bus to effectuate communication associated with one(s) of the cores 802. For example, the first bus 804 may be implemented by at least one of an Inter-Integrated Circuit (I2C) bus, a Serial Peripheral Interface (SPI) bus, a PCI bus, or a PCIe bus. Additionally or alternatively, the first bus 804 may be implemented by any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2 cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the local memory 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating-point operations. In yet other examples, the AL circuitry 816 may include first AL circuitry that performs integer-based operations and second AL circuitry that performs floating-point operations. In some examples, the AL circuitry 816 may be referred to as an Arithmetic Logic Unit (ALU).

The registers 818 are semiconductor-based structures to store data and/or instructions such as results of one or more of the operations performed by the AL circuitry 816 of the corresponding core 802. For example, the registers 818 may include vector register(s), SIMD register(s), general-purpose register(s), flag register(s), segment register(s), machine-specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure, such as by being distributed throughout the core 802 to shorten access time. The second bus 822 may be implemented by at least one of an I2C bus, a SPI bus, a PCI bus, or a PCIe bus.

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages.

The microprocessor 800 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 800, in the same chip package as the microprocessor 800 and/or in one or more separate packages from the microprocessor 800.

FIG. 9 is a block diagram of another example implementation of the programmable circuitry 712 of FIG. 7. In this example, the programmable circuitry 712 is implemented by FPGA circuitry 900. For example, the FPGA circuitry 900 may be implemented by an FPGA. The FPGA circuitry 900 can be used, for example, to perform operations that could otherwise be performed by the example microprocessor 800 of FIG. 8 executing corresponding machine readable instructions. However, once configured, the FPGA circuitry 900 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 800 of FIG. 8 described above (which is a general purpose device that may be programmed to execute some or all of the machine readable instructions represented by the flowchart(s) of FIGS. 4-6 but whose interconnections and logic circuitry are fixed once fabricated), the FPGA circuitry 900 of the example of FIG. 9 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 4-6. In particular, the FPGA circuitry 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 4-6. As such, the FPGA circuitry 900 may be configured and/or structured to effectively instantiate some or all of the operations/functions corresponding to the machine readable instructions of the flowchart(s) of FIGS. 4-6 as dedicated logic circuits to perform the operations/functions corresponding to those software instructions in a dedicated manner analogous to an ASIC. Therefore, the FPGA circuitry 900 may perform the operations/functions corresponding to the some or all of the machine readable instructions of FIGS. 4-6 faster than the general-purpose microprocessor can execute the same.

In the example of FIG. 9, the FPGA circuitry 900 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

The FPGA circuitry 900 of FIG. 9, includes example input/output (I/O) circuitry 902 to obtain and/or output data to/from example configuration circuitry 904 and/or external hardware 906. For example, the configuration circuitry 904 may be implemented by interface circuitry that may obtain a binary file, which may be implemented by a bit stream, data, and/or machine-readable instructions, to configure the FPGA circuitry 900, or portion(s) thereof. In some such examples, the configuration circuitry 904 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 906 may be implemented by external hardware circuitry. For example, the external hardware 906 may be implemented by the microprocessor 800 of FIG. 8.

The FPGA circuitry 900 also includes an array of example logic gate circuitry 908, a plurality of example configurable interconnections 910, and example storage circuitry 912. The logic gate circuitry 908 and the configurable interconnections 910 are configurable to instantiate one or more operations/functions that may correspond to at least some of the machine readable instructions of FIGS. 4-6 and/or other desired operations. The logic gate circuitry 908 shown in FIG. 9 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations/functions. The logic gate circuitry 908 may include other electrical structures such as look-up tables (LUTs), registers (e.g., flip-flops or latches), multiplexers, etc.

The configurable interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example dedicated operations circuitry 914. In this example, the dedicated operations circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the programmable circuitry 712 of FIG. 7, many other approaches are contemplated. For example, FPGA circuitry may include an on-board CPU, such as one or more of the example CPU 920 of FIG. 8. Therefore, the programmable circuitry 712 of FIG. 7 may additionally be implemented by combining at least the example microprocessor 800 of FIG. 8 and the example FPGA circuitry 900 of FIG. 9. In some such hybrid examples, one or more cores 802 of FIG. 8 may execute a first portion of the machine readable instructions represented by the flowchart(s) of FIGS. 4-6 to perform first operation(s)/function(s), the FPGA circuitry 900 of FIG. 9 may be configured and/or structured to perform second operation(s)/function(s) corresponding to a second portion of the machine readable instructions represented by the flowcharts of FIGS. 4-6, and/or an ASIC may be configured and/or structured to perform third operation(s)/function(s) corresponding to a third portion of the machine readable instructions represented by the flowcharts of FIGS. 4-6.

It should be understood that some or all of the circuitry of FIG. 2 may, thus, be instantiated at the same or different times. For example, same and/or different portion(s) of the microprocessor 800 of FIG. 8 may be programmed to execute portion(s) of machine-readable instructions at the same and/or different times. In some examples, same and/or different portion(s) of the FPGA circuitry 900 of FIG. 9 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 800 of FIG. 8 may execute machine readable instructions in one or more threads executing concurrently and/or in series. In some examples, the FPGA circuitry 900 of FIG. 9 may be configured and/or structured to carry out operations/functions concurrently and/or in series. Moreover, in some examples, some or all of the circuitry of FIG. 2 may be implemented within one or more virtual machines and/or containers executing on the microprocessor 800 of FIG. 8.

In some examples, the programmable circuitry 712 of FIG. 7 may be in one or more packages. For example, the microprocessor 800 of FIG. 8 and/or the FPGA circuitry 900 of FIG. 9 may be in one or more packages. In some examples, an XPU may be implemented by the programmable circuitry 712 of FIG. 7, which may be in one or more packages. For example, the XPU may include a CPU (e.g., the microprocessor 800 of FIG. 8, the CPU 920 of FIG. 9, etc.) in one package, a DSP (e.g., the DSP 922 of FIG. 9) in another package, a GPU in yet another package, and an FPGA (e.g., the FPGA circuitry 900 of FIG. 9) in still yet another package.

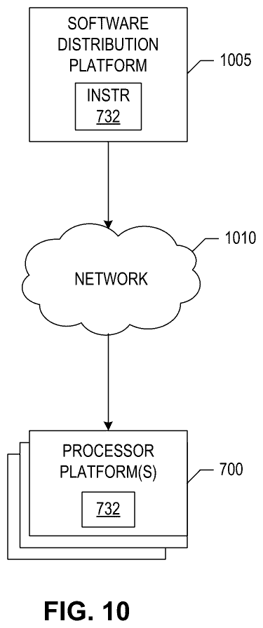

A block diagram illustrating an example software distribution platform 1005 to distribute software such as the example machine readable instructions 732 of FIG. 7 to other hardware devices (e.g., hardware devices owned and/or operated by third parties from the owner and/or operator of the software distribution platform) is illustrated in FIG. 10. The example software distribution platform 1005 may be implemented by any computer server, data facility, cloud service, etc., capable of storing and transmitting software to other computing devices. The third parties may be customers of the entity owning and/or operating the software distribution platform 1005. For example, the entity that owns and/or operates the software distribution platform 1005 may be a developer, a seller, and/or a licensor of software such as the example machine readable instructions 732 of FIG. 7. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the machine readable instructions 732, which may correspond to the example machine readable instructions of FIGS. 4-6, as described above. The one or more servers of the example software distribution platform 1005 are in communication with an example network 1010, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 732 from the software distribution platform 1005. For example, the software, which may correspond to the example machine readable instructions of FIG. 4-6, may be downloaded to the example programmable circuitry platform 700, which is to execute the machine readable instructions 732 to implement the global slice management circuitry. In some examples, one or more servers of the software distribution platform 1005 periodically offer, transmit, and/or force updates to the software (e.g., the example machine readable instructions 732 of FIG. 7) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that manage multiple network slices for compliance with global service level agreement throughput expectations. In some examples, a hierarchical approach is taken in which slice managers at a lower level of the hierarchical framework are provided throughput target values to implement at the multiple network slices. An upper level of the hierarchical framework determines and/or otherwise calculates the throughput target values in a manner that considers (a) throughput behaviors of other slices of a global network, (b) dynamic loads at the other slices of the global network, and dynamic occurrences of SLA violations and overprovisioning of the global network. In some examples disclosed herein, the calculation of the throughput policy considers the possibility that network throughput conditions may experience multi-dimensional fault behaviors. In some examples, the multi-dimensional fault behaviors include both SLA violations and instances of overprovisioning occurring during a time duration of network activity. In view of these multi-dimensional problems, some examples disclosed herein improve throughput predictions by tailoring and/or otherwise customizing a machine learning loss function based on influences of SLA violation instances and overprovisioning instances.

Example methods, apparatus, systems, and articles of manufacture to manage network slices are disclosed herein. Further examples and combinations thereof include the following:

Example 1 includes an apparatus comprising interface circuitry to access radio access network (RAN) data from a hierarchical network during a first time, machine-readable instructions, and at least one processor circuit to be programmed by the machine-readable instructions to determine a load for a plurality of slices associated with a lower level of the hierarchical network, detect a service level agreement (SLA) violation rate associated with aggregated first predicted throughput (TP) values associated with an upper level of the hierarchical network, detect an overprovisioning violation rate associated with the first TP values associated with the upper level of the hierarchical network, and train a machine learning (ML) prediction model with a loss function based on the load, the SLA violation rate, and the overprovisioning violation rate.

Example 2 includes the apparatus as defined in example 1, wherein one or more of the at least one processor circuit is to determine TP targets for the plurality of slices based on a difference between (a) the first TP values and (b) a global SLA TP value for the hierarchical network.

Example 3 includes the apparatus as defined in any one or more of examples 1-2, wherein one or more of the at least one processor circuit is to determine capable TP values for the plurality of slices based on (a) the TP targets and (b) ground truth TP values for the plurality of slices.

Example 4 includes the apparatus as defined in any one or more of examples 1-3, wherein one or more of the at least one processor circuit is to detect the SLA violation rate based on a difference between the capable TP values and a global load-adjusted SLA TP value.

Example 5 includes the apparatus as defined in any one or more of examples 1-4, wherein one or more of the at least one processor circuit is to determine the global load-adjusted SLA TP value based on a minimum one of (a) the ground truth TP values and (b) the global SLA TP value.

Example 6 includes the apparatus as defined in any one or more of examples 1-5, wherein one or more of the at least one processor circuit is to reduce at least one of the SLA violation rate or the overprovisioning violation rate based on execution of the trained ML prediction model during a second time.

Example 7 includes the apparatus as defined in any one or more of examples 1-6, wherein one or more of the at least one processor circuit is to generate second predicted TP values associated with the upper level of the hierarchical network based on execution of the trained ML prediction model during the second time.

Example 8 includes the apparatus as defined in any one or more of examples 1-7, wherein one or more of the at least one processor circuit is to determine the second predicted TP values based on load conditions of the hierarchical network during the second time.

Example 9 includes At least one non-transitory machine-readable medium comprising machine-readable instructions to cause at least one processor circuit to at least determine a load associated with a plurality of slices associated with a lower level of the hierarchical network, detect a service level agreement (SLA) violation rate associated with aggregated first predicted throughput (TP) values associated with an upper level of the hierarchical network, detect an overprovisioning violation rate associated with the first TP values associated with the upper level of the hierarchical network, and train a machine learning (ML) prediction model with a loss function based on the load, the SLA violation rate, and the overprovisioning violation rate.

Example 10 includes the at least one non-transitory machine-readable medium as defined in example 9, wherein the machine-readable instructions are to cause one or more of the at least one processor circuit to determine TP target setpoints for the plurality of slices based on a difference between (a) the first TP values and (b) a global SLA TP value for the hierarchical network.

Example 11 includes the at least one non-transitory machine-readable medium as defined in any one or more of examples 9-10, wherein the machine-readable instructions are to cause one or more of the at least one processor circuit to determine capable TP values for the plurality of slices based on (a) the TP target setpoints and (b) ground truth TP values for the plurality of slices.

Example 12 includes the at least one non-transitory machine-readable medium as defined in any one or more of examples 9-11, wherein the machine-readable instructions are to cause one or more of the at least one processor circuit to detect the SLA violation rate based on a difference between the capable TP values and a global load-adjusted SLA TP value.

Example 13 includes the at least one non-transitory machine-readable medium as defined in any one or more of examples 9-12, wherein the machine-readable instructions are to cause one or more of the at least one processor circuit to determine the global load-adjusted SLA TP value based on a minimum one of (a) the ground truth TP values and (b) the global SLA TP value.

Example 14 includes the at least one non-transitory machine-readable medium as defined in example 9, wherein the machine-readable instructions are to cause one or more of the at least one processor circuit to reduce at least one of the SLA violation rate or the overprovisioning violation rate based on execution of the trained ML prediction model during a second time.

Example 15 includes the at least one non-transitory machine-readable medium as defined in any one or more of examples 9-14, wherein the machine-readable instructions are to cause one or more of the at least one processor circuit to generate second predicted TP values associated with the upper level of the hierarchical network based on execution of the trained ML prediction model during the second time.

Example 16 includes the at least one non-transitory machine-readable medium as defined in any one or more of examples 9-15, wherein the machine-readable instructions are to cause one or more of the at least one processor circuit to determine the second predicted TP values based on load conditions of the hierarchical network during the second time.

Example 17 includes an apparatus comprising means for data acquisition to access radio access network (RAN) data from a hierarchical network during a first time, means for prediction to determine a load for a plurality of slices associated with a lower level of the hierarchical network, means for managing slices to detect a service level agreement (SLA) violation rate associated with aggregated first predicted throughput (TP) values associated with an upper level of the hierarchical network, and detect an overprovisioning violation rate associated with the first TP values associated with the upper level of the hierarchical network, and means for loss determination to train a machine learning (ML) prediction model with a loss function based on the load, the SLA violation rate, and the overprovisioning violation rate.

Example 18 includes the apparatus as defined in example 17, including means for planning to determine TP targets for the plurality of slices based on a difference between (a) the first TP values and (b) a global SLA TP value for the hierarchical network.

Example 19 includes the apparatus as defined in any one or more of examples 17-18, wherein the means for managing is to determine capable TP values for the plurality of slices based on (a) the TP targets and (b) ground truth values for the plurality of slices.

Example 20 includes the apparatus as defined in any one or more of examples 17-19, wherein the means for managing is to detect the SLA violation rate based on a difference between the capable TP values and a global load-adjusted SLA TP value.

Example 21 includes the apparatus as defined in any one or more of examples 17-20, wherein the means for managing is to determine the global load-adjusted SLA TP value based on a minimum one of (a) the ground truth TP values and (b) the global SLA TP value.

Example 22 includes the apparatus as defined in any one or more of examples 17-21, wherein the means for prediction is to reduce at least one of the SLA violation rate or the overprovisioning violation rate based on execution of the trained ML prediction model during a second time.

Example 23 includes the apparatus as defined in any one or more of examples 17-22, wherein the means for prediction is to generate second predicted TP values associated with the upper level of the hierarchical network based on execution of the trained ML prediction model during the second time.

Example 24 includes the apparatus as defined in example 22, wherein the means for prediction is to determine the second predicted TP values based on load conditions of the hierarchical network during the second time.

Example 25 includes a method comprising acquiring radio access network (RAN) data from a hierarchical network during a first time, determining a load for a plurality of slices associated with a lower level of the hierarchical network, detecting a service level agreement (SLA) violation rate associated with aggregated first predicted throughput (TP) values associated with an upper level of the hierarchical network, detecting an overprovisioning violation rate associated with the first TP values associated with the upper level of the hierarchical network, and training a machine learning (ML) prediction model with a loss function based on the load, the SLA violation rate, and the overprovisioning violation rate.

Example 26 includes the method as defined in example 25, further including determining TP targets for the plurality of slices based on a difference between (a) the first TP values and (b) a global SLA TP value for the hierarchical network.

Example 27 includes the method as defined in any one or more of examples 25-26, further including determining capable TP values for the plurality of slices based on (a) the TP targets and (b) ground truth TP values for the plurality of slices.

Example 28 includes the method as defined in any one or more of examples 25-27, further including detecting the SLA violation rate based on a difference between the capable TP values and a global load-adjusted SLA TP value.

Example 29 includes the method as defined in any one or more of examples 25-28, further including determining the global load-adjusted SLA TP value based on a minimum one of (a) the ground truth TP values and (b) the global SLA TP value.

Example 30 includes the method as defined in any one or more of examples 25-29, further including reducing at least one of the SLA violation rate or the overprovisioning violation rate based on executing the trained ML prediction model during a second time.

Example 31 includes the method as defined in any one or more of examples 25-30, further including generating second predicted TP values associated with the upper level of the hierarchical network based on execution of the trained ML prediction model during the second time.

Example 32 includes the method as defined in any one or more of examples 25-31, further including determining the second predicted TP values based on load conditions of the hierarchical network during the second time.

Example 33 includes an apparatus comprising interface circuitry to access radio access network (RAN) data from a network, machine-readable instructions, and at least one processor circuit to be programmed by the machine-readable instructions to generate a first global data structure of first predicted throughput (TP) values associated with localized network slices during a first time, calculate TP target setpoints for the localized network slices based on a difference between (a) the first predicted TP values and (b) a global service level agreement (SLA) TP value associated with the network, calculate capable TP values of the localized network slices based on (a) the TP target setpoints and (b) ground truth TP values associated with the network slices, and train a machine learning (ML) prediction model with a loss function based on (a) the capable TP values and (b) a TP policy.

Example 34 includes the apparatus as defined in example 33, wherein the TP policy includes an SLA violation rate and a resource overprovisioning rate of the network.

Example 35 includes the apparatus as defined in any one or more of examples 33-34, wherein one or more of the at least one processor circuit is to determine the SLA violation rate based on a difference between the capable TP values and a global load-adjusted SLA TP value.

Example 36 includes the apparatus as defined in any one or more of examples 33-35, wherein one or more of the at least one processor circuit is to determine the global load-adjusted SLA TP value based on a minimum one of (a) the ground truth TP values and (b) the global SLA TP value.

Example 37 includes the apparatus as defined in any one or more of examples 33-36, wherein one or more of the at least one processor circuit is to cause generation of a second global data structure associated with second predicted TP values generated based on execution of the ML prediction model during a second time.

Example 38 includes the apparatus as defined in any one or more of examples 33-37, wherein one or more of the at least one processor circuit is to calculate the second predicted TP values based on load conditions of the network during the second time.

Example 39 includes the apparatus as defined in any one or more of examples 33-38, wherein one or more of the at least one processor circuit is to apply the loss function to a gradient descent algorithm associated with the ML prediction model, the gradient descent algorithm to iteratively modify parameters of the ML prediction model during the second time.

Example 40 includes an apparatus comprising interface circuitry, machine-readable instructions, and at least one processor circuit to be programmed by the machine-readable instructions to generate achievable throughput (TP) values for network slices based on (a) a TP policy and (b) ground truth TP values during a first time, generate load adjusted service level agreement (SLA) TP values based on (a) the ground truth TP values during the first time and (b) a global SLA target TP value, and generate a loss function based on a difference between the load adjusted SLA TP values and the achievable TP values during the first time.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry to access radio access network (RAN) data from a hierarchical network during a first time;
machine-readable instructions; and
at least one processor circuit to be programmed by the machine-readable instructions to:
determine a load for a plurality of slices associated with a lower level of the hierarchical network;
detect a service level agreement (SLA) violation rate associated with aggregated first predicted throughput (TP) values associated with an upper level of the hierarchical network;
detect an overprovisioning violation rate associated with the first TP values associated with the upper level of the hierarchical network; and
train a machine learning (ML) prediction model with a loss function based on the load, the SLA violation rate, and the overprovisioning violation rate.

2. The apparatus as defined in claim 1, wherein one or more of the at least one processor circuit is to determine TP targets for the plurality of slices based on a difference between (a) the first TP values and (b) a global SLA TP value for the hierarchical network.

3. The apparatus as defined in claim 2, wherein one or more of the at least one processor circuit is to determine capable TP values for the plurality of slices based on (a) the TP targets and (b) ground truth TP values for the plurality of slices.

4. The apparatus as defined in claim 3, wherein one or more of the at least one processor circuit is to detect the SLA violation rate based on a difference between the capable TP values and a global load-adjusted SLA TP value.

5. The apparatus as defined in claim 4, wherein one or more of the at least one processor circuit is to determine the global load-adjusted SLA TP value based on a minimum one of (a) the ground truth TP values and (b) the global SLA TP value.

6. The apparatus as defined in claim 1, wherein one or more of the at least one processor circuit is to reduce at least one of the SLA violation rate or the overprovisioning violation rate based on execution of the trained ML prediction model during a second time.

7. The apparatus as defined in claim 6, wherein one or more of the at least one processor circuit is to generate second predicted TP values associated with the upper level of the hierarchical network based on execution of the trained ML prediction model during the second time.

8. The apparatus as defined in claim 7, wherein one or more of the at least one processor circuit is to determine the second predicted TP values based on load conditions of the hierarchical network during the second time.

9. At least one non-transitory machine-readable medium comprising machine-readable instructions to cause at least one processor circuit to at least:
determine a load associated with a plurality of slices associated with a lower level of the hierarchical network;
detect a service level agreement (SLA) violation rate associated with aggregated first predicted throughput (TP) values associated with an upper level of the hierarchical network;
detect an overprovisioning violation rate associated with the first TP values associated with the upper level of the hierarchical network; and
train a machine learning (ML) prediction model with a loss function based on the load, the SLA violation rate, and the overprovisioning violation rate.

10. The at least one non-transitory machine-readable medium as defined in claim 9, wherein the machine-readable instructions are to cause one or more of the at least one processor circuit to determine TP target setpoints for the plurality of slices based on a difference between (a) the first TP values and (b) a global SLA TP value for the hierarchical network.

11. The at least one non-transitory machine-readable medium as defined in claim 10, wherein the machine-readable instructions are to cause one or more of the at least one processor circuit to determine capable TP values for the plurality of slices based on (a) the TP target setpoints and (b) ground truth TP values for the plurality of slices.

12. The at least one non-transitory machine-readable medium as defined in claim 11, wherein the machine-readable instructions are to cause one or more of the at least one processor circuit to detect the SLA violation rate based on a difference between the capable TP values and a global load-adjusted SLA TP value.

13. The at least one non-transitory machine-readable medium as defined in claim 12, wherein the machine-readable instructions are to cause one or more of the at least one processor circuit to determine the global load-adjusted SLA TP value based on a minimum one of (a) the ground truth TP values and (b) the global SLA TP value.

14. The at least one non-transitory machine-readable medium as defined in claim 9, wherein the machine-readable instructions are to cause one or more of the at least one processor circuit to reduce at least one of the SLA violation rate or the overprovisioning violation rate based on execution of the trained ML prediction model during a second time.

15. The at least one non-transitory machine-readable medium as defined in claim 14, wherein the machine-readable instructions are to cause one or more of the at least one processor circuit to generate second predicted TP values associated with the upper level of the hierarchical network based on execution of the trained ML prediction model during the second time.

16. The at least one non-transitory machine-readable medium as defined in claim 15, wherein the machine-readable instructions are to cause one or more of the at least one processor circuit to determine the second predicted TP values based on load conditions of the hierarchical network during the second time.

17. An apparatus comprising:
means for data acquisition to access radio access network (RAN) data from a hierarchical network during a first time;
means for prediction to determine a load for a plurality of slices associated with a lower level of the hierarchical network;
means for managing slices to:
detect a service level agreement (SLA) violation rate associated with aggregated first predicted throughput (TP) values associated with an upper level of the hierarchical network; and
detect an overprovisioning violation rate associated with the first TP values associated with the upper level of the hierarchical network; and
means for loss determination to train a machine learning (ML) prediction model by generating a loss function based on the load, the SLA violation rate, and the overprovisioning violation rate.

18. The apparatus as defined in claim 17, including means for planning to determine TP targets for the plurality of slices based on a difference between (a) the first TP values and (b) a global SLA TP value for the hierarchical network.

19. The apparatus as defined in claim 18, wherein the means for managing is to determine capable TP values for the plurality of slices based on (a) the TP targets and (b) ground truth values for the plurality of slices.

20. The apparatus as defined in claim 19, wherein the means for managing is to detect the SLA violation rate based on a difference between the capable TP values and a global load-adjusted SLA TP value.
